(19) United States
(12) Patent Application Publication
(10) Pub. No.: US 2018/0108170 A1
(43) Pub. Date: Apr. 19, 2018

(54) DATA PROCESSING APPARATUS, THREE-DIMENSIONAL OBJECT CREATING SYSTEM, AND NON-TRANSITORY COMPUTER READABLE MEDIUM

(71) Applicant: FUJI XEROX CO., LTD., Tokyo (JP)

(72) Inventors: Koichi MATSUBARA, Kanagawa (JP); Kenji HARA, Kanagawa (JP); Ryosuke YONESAKA, Kanagawa (JP)

(73) Assignee: FUJI XEROX CO., LTD., Tokyo (JP)

(21) Appl. No.: 15/587,459

(22) Filed: May 5, 2017

(30) Foreign Application Priority Data
Oct. 19, 2016 (JP) 2016-205371

(51) Int. Cl. G06T 15/08; G06T 15/04; B29C 67/00

(52) U.S. Cl. CPC G06T 15/08; B33Y 50/00; B29C 67/0088; G06T 15/04

(57) ABSTRACT

A data processing apparatus includes an accepting unit that accepts first data defining, for each specific surface region, a shape of a three-dimensional object and a color of a surface of the three-dimensional object; and a generating unit that generates color voxel data from the accepted first data, the generating unit generating the color voxel data so that color information indicative of presence of a color is given to inner voxels within a larger depth from a surface voxel in a region of the first data where a density of the color of the surface is higher than in a region of the first data where the density of the color of the surface is lower.

### CROSS-REFERENCE TO RELATED APPLICATIONS

This application is based on and claims priority under 35 USC 119 from Japanese Patent Application No. 2016-205371 filed Oct. 19, 2016.

### BACKGROUND

### (i) Technical Field

The present invention relates to a data processing apparatus, a three-dimensional object creating system, and a non-transitory computer readable medium.

### (ii) Related Art

Conventionally, three-dimensional object creating apparatuses, so-called 3D printers have been proposed. In three-dimensional object creation using a 3D printer, a technique of accepting, as input data, data (e.g., polygon data) defining, for each specific surface region, a shape of a created object and a color of a surface of the created object, converting the accepted data into voxel data that is a data format processable in the object creating apparatus, and then creating the object on the basis of the voxel data is generally known.

In cases where an object creating apparatus that is capable of outputting plural coloring materials is used, a color three-dimensional object can be created on the basis of color voxel data in which color information is allocated to each voxel.

### SUMMARY

In generation of color voxel data from input data, halftoning processing is sometimes performed on an object surface. This means that the strength of a color of the input data is expressed by the size of a colored region on an object surface (a ratio of voxels to which a chromatic color is allocated to surface voxels). In this case, as for inner voxels that are not located on the object surface, the same color information as corresponding surface voxels is allocated to inner voxels located within a certain distance (depth) from the surface voxels toward the inner side of the object irrespective of the strength of the color of the input data.

However, in generation of color voxel data from input data indicative of a color three-dimensional object, in cases where the same color information as surface voxels is uniformly allocated to inner voxels located within a certain depth from the surface voxels irrespective of the strength of the color of the input data, the strength of the color of the input data can be expressed only by a ratio of colored voxels to the surface voxels. This limits color reproducibility of an obtained three-dimensional object.

According to an aspect of the invention, there is provided a data processing apparatus including an accepting unit that accepts first data defining, for each specific surface region, a shape of a three-dimensional object and a color of a surface of the three-dimensional object; and a generating unit that generates color voxel data from polygon data that constitute the accepted first data, the generating unit generating the color voxel data so that color information indicative of presence of a color is given to inner voxels within a larger depth from a surface voxel in a region of the first data where a density of the color of the surface is higher than in a region of the first data where the density of the color of the surface is lower.

### BRIEF DESCRIPTION OF THE DRAWINGS

An exemplary embodiment of the present invention will be described in detail based on the following figures, wherein:

FIG. 1 illustrates a configuration of a system;

FIG. 2 is a flowchart of overall processing;

FIGS. 3A through 3C are explanatory views for explaining slice data;

FIG. 4 is a flowchart of processing for determining a closest polygon and depth data;

FIG. 5 is an explanatory view for explaining calculation of a distance;

FIG. 6 is a flowchart of processing for determining whether a voxel is a color voxel or an achromatic color voxel;

FIGS. 7A and 7B are explanatory views illustrating an example of a total color amount and a color voxel condition;

FIG. 8 is a flowchart of another processing for determining whether a voxel is a color voxel or an achromatic color voxel;

FIG. 9 is an explanatory view illustrating an example of a color voxel condition determining expression;

FIG. 10 is a first explanatory view illustrating a relationship between input data and output data; and

FIGS. 11A and 11B are second explanatory views illustrating a relationship between input data and output data.

### DETAILED DESCRIPTION

An exemplary embodiment of the present invention is described below with reference to the drawings. Terms used herein are defined as follows.

A “voxel” refers to a small cube that is a minimum unit in expression of a three-dimensional object. A voxel corresponds to a pixel of a two-dimensional image. A three-dimensional object can be visualized by combining voxels. Therefore, when a three-dimensional object is created by an object creating apparatus, the three-dimensional object is generally created on the basis of data describing the object to be created as a group of voxels. As in the case of pixels of a two-dimensional image, an object can be colored for each voxel by allocating color information to each voxel.

“Voxel data” refers to data describing an object to be created as a group of voxels.

“Color voxel data” refers to voxel data in which color information is allocated to each voxel.

A “surface voxel” refers to a voxel that is located on a surface of a three-dimensional object among all voxels that constitute the three-dimensional object.

An “inner voxel” refers to a voxel that is not located on a surface of a created object among all voxels that constitute the created object.

“Color” refers to a chromatic color and an achromatic color of low brightness (e.g., other than white and transparent).

“Colorless” refers to an achromatic color of high brightness (e.g., white and transparent).

Some full-color 3D printers can eject ink of only a single color to a single pixel or voxel (a regular grid unit in a three-dimensional space) only in a constant amount. Although a full-color 2D printer can express Blue 100% by outputting Cyan 100% and Magenta 100%, for example, when Blue 100% is input, such a full-color 3D printer outputs Cyan 50% and Magenta 50% at a volume ratio and therefore obtains substantially Blue 50%.

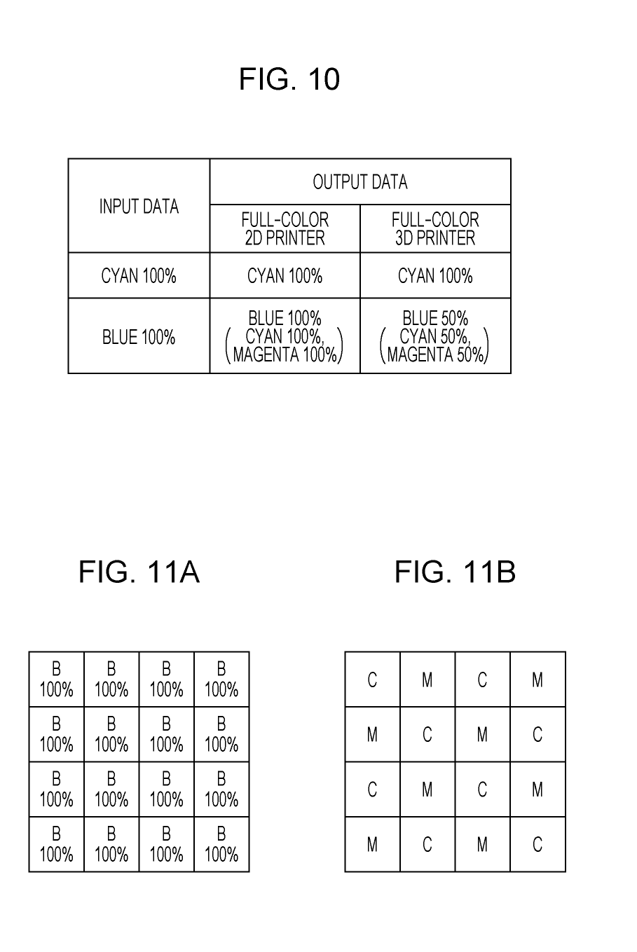

FIG. 10 illustrates a relationship between input data and output data in a full-color 2D printer and a full-color 3D printer that can eject ink of only a single color to a single pixel or voxel only in a constant amount.

When the input data is Cyan 100%, both of the full-color 2D printer and the full-color 3D printer can achieve Cyan 100% as output data. The same applies to a case where the input data is, for example, magenta.

Meanwhile, in cases where the input data is Blue 100%, the full-color 2D printer can output Blue 100%, but the full-color 3D printer outputs substantially 50%, which is paler than in the cases where a single-color is used.

FIGS. 11A and 11B schematically illustrate processing performed in this case. FIG. 11A illustrates input data of Blue (B) 100%. FIG. 11B illustrates output data of the full-color 3D printer. Since ink of only a single color can be ejected to a single pixel or voxel, cyan (C) and magenta (M) are alternately ejected, and only substantially Blue 50% can be obtained accordingly. The same applies to other multi-colors than blue.

Although a multi-color can be made stronger by increasing the number of colored layers, a single-color is also made stronger, and therefore a difference in color strength between the single-color and the multi-color is not addressed. The present exemplary embodiment addresses especially such a problem.

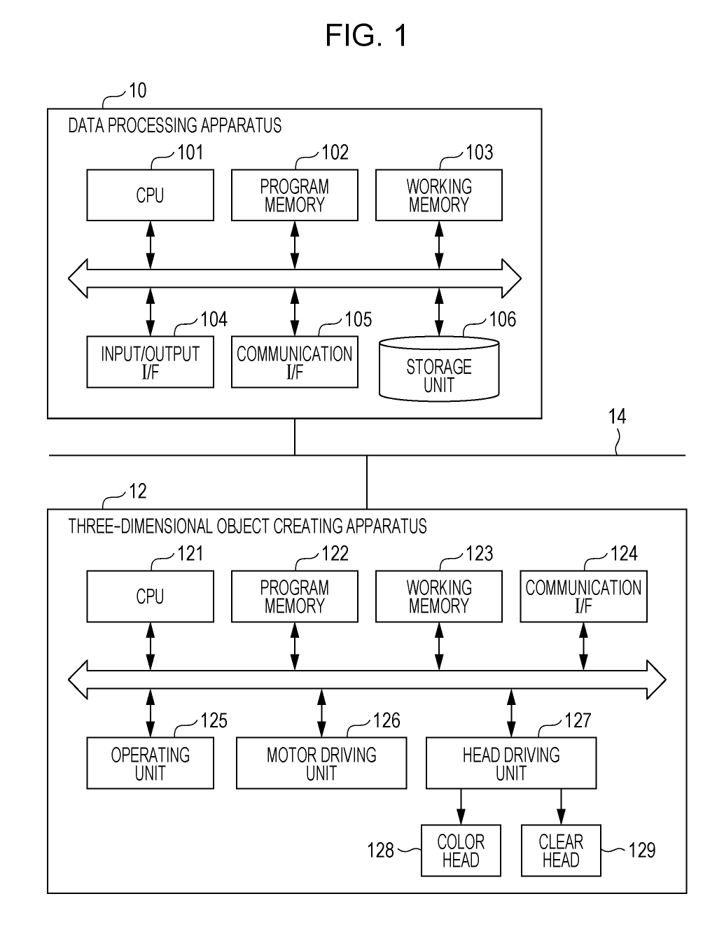

FIG. 1 illustrates a configuration of a three-dimensional object creating system according to the present exemplary embodiment. The three-dimensional object creating system includes a data processing apparatus 10 and a three-dimensional object creating apparatus 12. The data processing apparatus 10 and the three-dimensional object creating apparatus 12 are connected over a communication network 14.

The data processing apparatus 10 receives three-dimensional object data (3D data), performs predetermined processing on the three-dimensional object data, and then supplies the three-dimensional object data to the three-dimensional object creating apparatus 12 over the communication network 14. The data processing apparatus 10 includes an accepting unit and a generating unit. Specifically, the data processing apparatus 10 includes a CPU 101, a program memory 102 such as a ROM, an SSD, or an HDD, a working memory 103 such as a RAM, an input/output interface (I/F) 104 for input to and output from a keyboard, a mouse, an optical disc such as a CD-ROM, a semiconductor memory such as a USB memory or an SD card, a display, and the like, a communication interface (I/F) 105 for communication with external apparatuses including the three-dimensional object creating apparatus 12, and a storage unit 106 such as an HDD. The accepting unit is the input/output I/F 104 and the communication I/F 105, and the generating unit is the CPU 101. The data processing apparatus 10 can be, for example, a computer or a tablet terminal.

The CPU 101 performs processing on three-dimensional object data by reading out and executing a processing program stored in the program memory 102 and then supplies the three-dimensional object data to the three-dimensional object creating apparatus 12 through the communication I/F 105 and the communication network 14. Processing mainly executed by the CPU 101 is processing for determining, for each voxel, whether the voxel becomes a color voxel or an achromatic color voxel. More specifically, the CPU 101 executes the following processing:

(i) Processing for converting polygons that constitute three-dimensional object data (3D data) into voxels

(ii) Processing for determining, for each voxel, whether the voxel becomes a color voxel or an achromatic color voxel

(iii) Processing for determining color data of a color voxel

(iv) Processing for converting color data of each voxel into a data format processable by the three-dimensional object creating apparatus 12.

The processing for determining whether a voxel becomes a color voxel or an achromatic color voxel includes processing for calculating a distance to a polygon closest to the voxel to be processed and processing for calculating a color density of the closest polygon. In the processing for determining color data of a color voxel, the color density of the closest polygon is used, and the distance to the closest polygon is also used as needed. The processing for converting color data of each voxel into a data format processable by the three-dimensional object creating apparatus 12 includes processing for converting the color data of the color voxel into CMYK, halftoning processing, and slicing processing that will be described later.

The three-dimensional object creating apparatus 12 functions as a 3D printer. The three-dimensional object creating apparatus 12 includes a CPU 121, a program memory 122 such as a ROM, a working memory 123, a communication interface (I/F) 124, an operating unit 125, a motor driving unit 126, a head driving unit 127, a color head 128, and a clear head 129.

The CPU 121 drives motors and heads by supplying control signals to the motor driving unit 126 and the head driving unit 127 by using the three-dimensional object data supplied from the data processing apparatus 10 through the communication I/F 124 on the basis of an operation command from the operating unit 125 in accordance with a processing program stored in the program memory 122.

The motor driving unit 126 drives motors including a supporting table (stage) moving motor for moving a supporting table that supports a created object and a head moving motor.

The head driving unit 127 controls ejection of ink (liquid for object creation) of the color head 128 and the clear head 129. The color head 128 is made up of a cyan (C) head, a magenta (M) head, a yellow (Y) head, and a black (K) head. The clear head 129 ejects transparent ink (liquid for object creation) that is not colored. The head driving unit 127 controls ejection, for example, by driving a piezoelectric element provided in an ejection channel of each head. However, a driving method is not limited to this. The clear head 129 may eject white ink instead of transparent ink. White or transparent is defined as an achromatic color relative to colors such as cyan, magenta, yellow, and black.

The three-dimensional object creating apparatus 12 creates a desired three-dimensional object by ejecting ink from the color head 128 and the clear head 129 by using slice data of the three-dimensional object supplied from the data processing apparatus 10 and sequentially stacking slices in a height direction. Specifically, the three-dimensional object creating apparatus 12 creates a three-dimensional object by ejecting ink (liquid for object creation) while sequentially moving the color head 128 and the clear head 129 in directions of three axes, i.e., X, Y, and Z axes. Alternatively, the three-dimensional object creating apparatus 12 may sequentially move a stage provided below the color head 128 and the clear head 129 in the directions of three axes, i.e., X, Y, and Z axes while fixing the color head 128 and the clear head 129.

The color head 128 may be made up of a cyan (C) head, a magenta (M) head, and a yellow (Y) head or may be made up of not only a cyan (C) head, a magenta (M) head, a yellow (Y) head, and a black (K) head, but also a head of another color.

The communication network 14 is, for example, the Internet, a local area network (LAN), Wi-Fi, or Bluetooth (Registered Trademark).

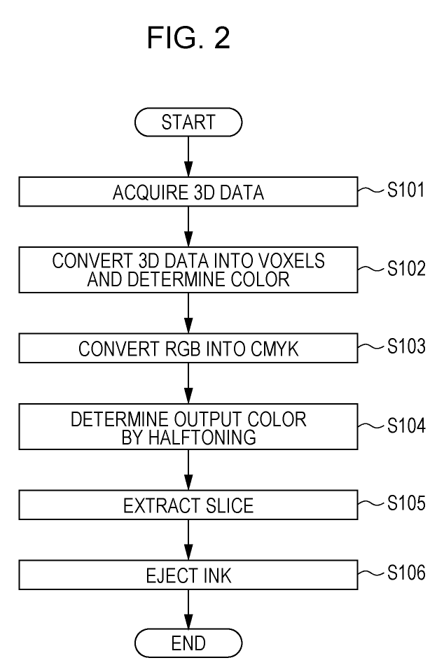

FIG. 2 is a flowchart of overall processing of the three-dimensional object creating system.

First, the CPU 101 of the data processing apparatus 10 acquires three-dimensional object data (3D data) (S101). The 3D data may be acquired from a keyboard, an optical disc such as a CD-ROM, a USB memory, or the like through the input/output I/F 104 or may be acquired from another computer connected to the communication network 14 through the communication I/F 105. The 3D data is data indicative of a three-dimensional shape of an object and indicates an external shape and a color of a surface of the object. The 3D data is constituted, for example, by polygons and includes color data (e.g., RGB data) of a surface of the object. The polygons are elements used to express an object by a combination of triangles and rectangles. The format of the 3D data is not limited in particular and may be a data format created by CAD software or may be a data format created by CG software.

Next, the CPU 101 of the data processing apparatus 10 converts the 3D data into voxel data in accordance with the processing program stored in the program memory 102 and determines color data of the voxel data (S102). The voxel data includes depth data D concerning a depth from the object surface and color data (r, g, and b).

The depth data D is a distance between a voxel center and a polygon closest to the voxel center. The depth data D is, for example, an average of distances from the voxel center to points of the closest polygon (vertexes of a triangle if the polygon is a triangle).

The color data is set by determining, for each voxel, whether the voxel becomes a color voxel or an achromatic color (white or transparent) voxel on the basis of a color density of the closest polygon and the depth data D. The color density of the closest polygon is calculated from the color data of the polygon. The CPU 101 basically generates color voxels so that voxels within a larger depth in the three-dimensional object become color voxels as the color density of the closest polygon becomes larger.

Next, the CPU 101 of the data processing apparatus 10 converts color data (r, g, and b) allocated to each voxel into CMYK data in accordance with the processing program (S103). Conversion from RGB into CMYK is known, and complementary color conversion, a look-up table (LUT), or the like can be used as in the case of a 2D printer. In cases where the clear head 129 of the three-dimensional object creating apparatus 12 ejects colorless transparent ink (liquid for object creation) and where a color indicated by the color data (r, g, and b) is white (all of R, G, and B values are maximum), the CPU 101 of the data processing apparatus 10 converts the color data (r, g, and b) into an achromatic color.

Next, the CPU 101 of the data processing apparatus 10 determines an output color of each voxel by halftoning processing in accordance with the processing program (S104). The halftoning processing is known, and error diffusion, a threshold dither matrix, or the like can be used as in the case of a 2D printer. For example, in halftoning processing using a threshold dither matrix, a three-dimensional threshold dither matrix corresponding to each of C, M, Y, and K is stored in the program memory 102 in advance, and color data of each color is compared with a value of the threshold dither matrix. In cases where the color data is equal to or larger than a threshold value, the color data is determined to be ON, and in cases where the color data is smaller than the threshold value, the color data is determined to be OFF. Only color data that has been determined to be ON is left.

As a result of the halftoning processing, the color data of the voxel is turned into data indicative of any one of cyan (C), magenta (M), yellow (Y), black (K), and an achromatic color (white or transparent).

Next, the CPU 101 of the data processing apparatus 10 extracts data of a single slice from the voxels for which color data has been determined in accordance with the processing program (S105). The single slice corresponds to an amount that can be ejected per movement of the color head 128 and the clear head 129 of the three-dimensional object creating apparatus 12. The CPU 101 that has extracted slice data from the voxels transmits the extracted slice data to the three-dimensional object creating apparatus 12 through the communication I/F 105 and the communication network 14.

The CPU 121 of the three-dimensional object creating apparatus 12 receives the slice data through the communication I/F 124 and creates a three-dimensional object by ejecting ink (liquid for object creation) from the color head 128 and the clear head 129 by controlling the motor driving unit 126 and the head driving unit 127 by using the slice data (S106). The CPU 121 of the three-dimensional object creating apparatus 12 creates the three-dimensional object by stacking slices in a height direction by repetition of slice extraction and ink ejection from the color head 128 and the clear head 129.

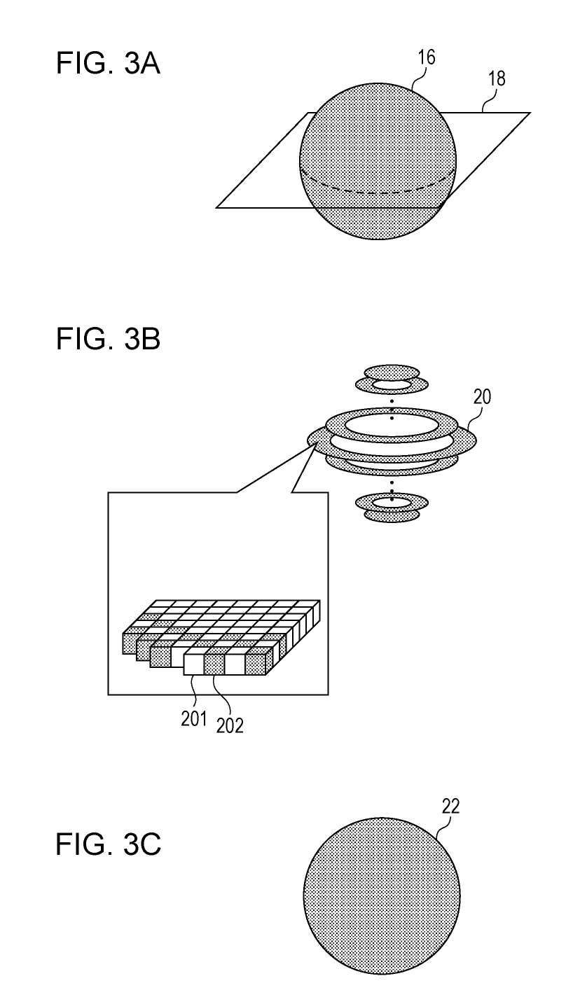

FIGS. 3A through 3C schematically illustrate slice data. Once 3D data is converted into voxel data and color data of voxels is determined, 3D data 16 constituted by these voxels is sequentially sliced on a predetermined slicing plane 18 as illustrated in FIG. 3A, and slice data 20 is extracted as illustrated in FIG. 3B. The slice data 20 is made up of plural pieces of voxel data and includes data of an achromatic color voxel 201 and data of a color voxel 202. Whether a voxel becomes the achromatic color voxel 201 or the color voxel 202 is automatically determined on the basis of a color density of a polygon closest to the voxel and depth data D as described above.

Next, a method for determining color data of each voxel is described.

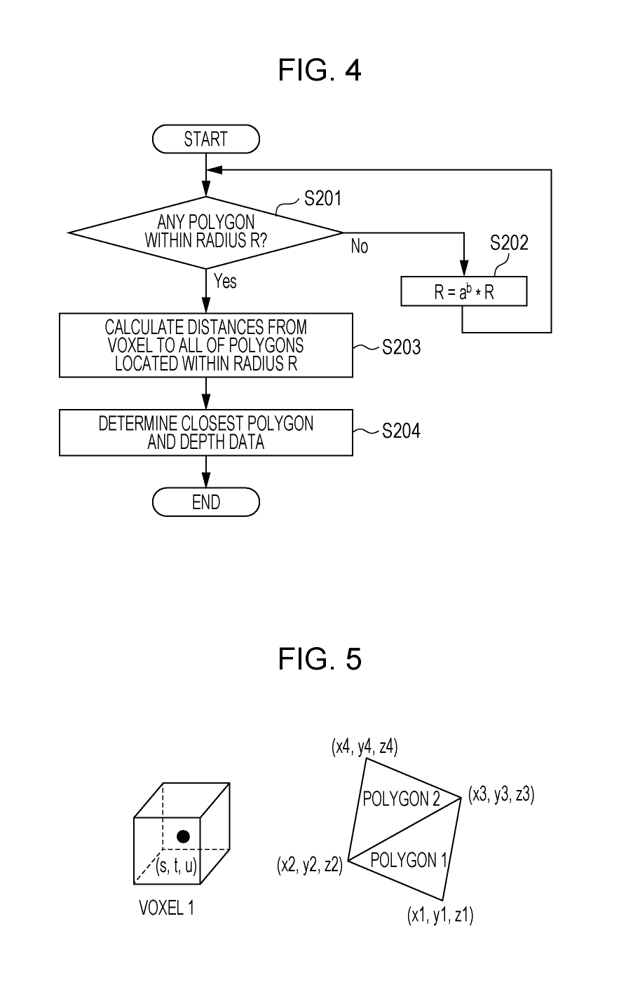

FIG. 4 is a flowchart illustrating how processing for searching for a closest polygon and calculating depth data D in order to determine color data of each voxel is performed in the CPU 101 of the data processing apparatus 10.

First, the CPU 101 initially sets a radius R for a voxel to be processed and determines whether or not there is a polygon within the radius R (S201). In cases where there is no polygon within the radius R (NO in S201), the CPU 101 updates the radius R to a larger one according to the following formula (S202):

R=a^{b}*R

where a and b are coefficients and are larger than 0. For example, assume that a is 1.5 and b is 1, R=1.5R. This means that the radius R is increased 1.5 times.

In cases where there is a polygon within the radius R or in cases where there is a polygon within the increased radius R (YES in S201), a distance between the voxel to be processed and all polygons that are located within the radius R is calculated (S203). As a distance between a voxel and a polygon, a normal may be calculated or an average of distances from a voxel center to points of the polygon may be calculated. After distances to all of the polygons located within the radius R are calculated, a polygon closest to the voxel to be processed is determined by comparing these distances, and a distance to this closest polygon is determined as depth data D (S204).

FIG. 5 schematically illustrates processing for calculating distances between a voxel (voxel 1) to be processed and polygons (a polygon 1 and a polygon 2) located within the radius R.

Assume that a central position of the voxel 1 is (s, t, u), positions of vertexes of the polygon 1 are (x1, y1, z1), (x2, y2, z2), and (x3, y3, z3), and positions of vertexes of the polygon 2 are (x2, y2, z2), (x3, y3, z3), and (x4, y4, z4) (the polygon 1 and the polygon 2 share two vertexes), a distance between the voxel 1 and the polygon 1 is calculated, for example, as follows:

(((s−x1)²+(t−y1)²−(u−z1)²)^{1/2}+((s−x2)²+(t−y2)²−(u−z2)²)^{1/2}+((s−x3)²+(t−y3)²−(u−z3)²)^{1/2})/3.

Meanwhile, a distance between the voxel 1 and the polygon 2 is calculated as follows:

(((s−x2)²+(t−y2)²−(u−z2)²)^{1/2}+((s−x3)²+(t−y3)²−(u−z3)²)^{1/2}+((s−x4)²+(t−y4)²−(u−z4)²)^{1/2})/3.

In cases where the distance between the voxel 1 and the polygon 1 is shorter than the distance between the voxel 1 and the polygon 2, the distance between the voxel 1 and the polygon 1 is determined as depth data D. The CPU 101 performs the processing for all of the voxels and stores a result of computation in the working memory 103. Assume that the voxels are a voxel 1, a voxel 2, a voxel 3, . . . , a closest polygon and depth data are stored, for each voxel, in the working memory 103 so as to be associated with each other as follows:

voxel 1: depth data D1, closest polygon 1

voxel 2: depth data D2, closest polygon 2

voxel 3: depth data D3, closest polygon 3.

As for a closest polygon, color data may be stored in association with the closest polygon.

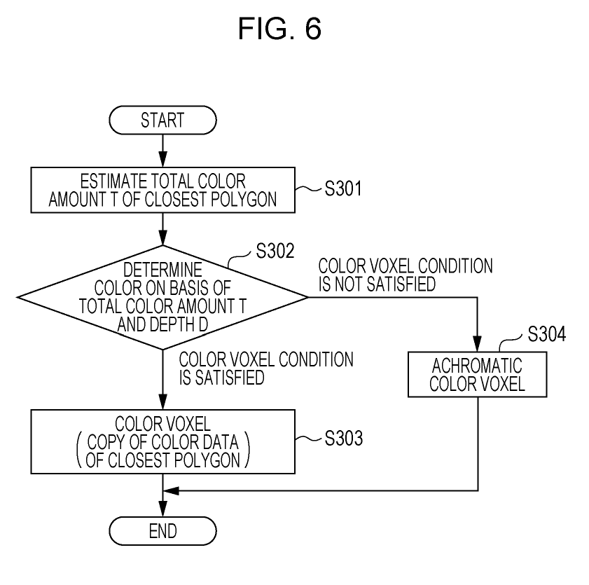

FIG. 6 is a flowchart illustrating how processing for determining color data of each voxel is performed in the CPU 101 of the data processing apparatus 10.

First, the CPU 101 determines a total color amount T as a color density of a closest polygon determined for each voxel in S204 of FIG. 4 in accordance with the processing program (S301). The CPU 101 calculates the total color amount T by performing complementary color conversion of color data (r, g, b) of the closest polygon into CMY. In the complementary color conversion, a reversal value of an input density of R is set as an input density of C, a reversal value of an input density of G is set as an input density of M, and a reversal value of an input density of B is set as an input density of Y as follows:

C(%)=100(%)−r

M(%)=100(%)−g

Y(%)=100(%)−b

The total color density T is a sum of the CMY densities and is expressed as follows:

T=C(%)+M(%)+Y(%)=300(%)−(r+g+b)

Next, the CPU 101 determines color data of the voxel to be processed on the basis of the calculated total color amount T1 and the depth data D calculated in S204 of FIG. 4 in accordance with the processing program (S302). Specifically, the CPU 101 determines that a voxel that satisfies a preset color voxel condition is a color voxel and uses the color data of the closest polygon as it is (S303). Meanwhile, the CPU 101 determines that a voxel that does not satisfy the preset color voxel condition is an achromatic color voxel (S304). The color voxel condition is stored in the form of a table or a function in the program memory 102 in advance as part of the processing program. The color voxel condition is generally set so that a voxel is more likely to become a color voxel as the total color amount T becomes larger and so that a voxel is more likely to become a color voxel as the depth data D becomes smaller.

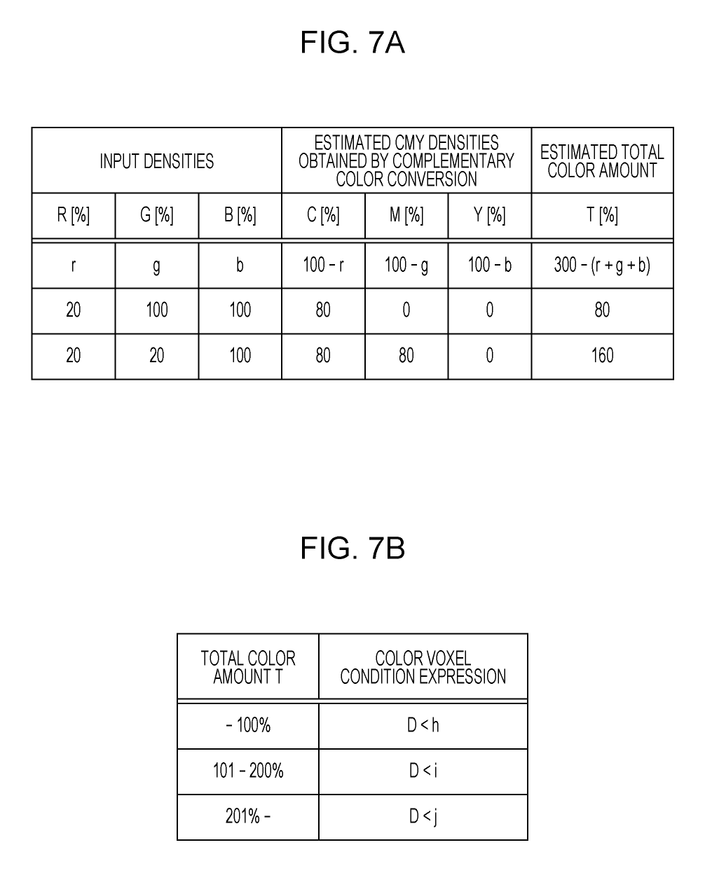

FIGS. 7A and 7B illustrate an example of the total color amount T and the color voxel condition. FIG. 7A illustrates examples of the total color amount T. In cases where an input density of a closest polygon is r=20%, g=100%, and b=100%, a result of complementary color conversion is C=80%, M=0%, and Y=0%, and therefore the total color amount T is T=80%. In cases where an input density of a closest polygon is r=20%, g=20%, and b=100%, a result of complementary color conversion is C=80%, M=80%, and Y=0%, and therefore the total color amount T is T=160%.

FIG. 7B illustrates an example of the color voxel condition. A condition on which a voxel becomes a color voxel is defined, for each total color amount T, as a relationship between depth data D and a threshold value. Specifically, in cases where the total color amount T is 100% or less, a voxel that satisfies D<h becomes a color voxel. In cases where the total color amount T is in a range from 101% to 200%, a voxel that satisfies D<i becomes a color voxel. In cases where the total color amount T is 201% or more, a voxel that satisfies D<j becomes a color voxel. It is assumed here that h<i<j.

According to this color voxel condition, among voxels of the same total color amount T, a voxel that has small depth data D, specifically depth data D that is smaller than a threshold value becomes a color voxel, and a voxel that has large depth data D, specifically depth data D that is equal to or larger than the threshold value becomes an achromatic color voxel. Among voxels having the same depth data D, a voxel of a larger total color amount T is more likely to become color voxel since a threshold value becomes larger as the total color amount T becomes larger.

The CPU 101 performs, for all of the voxels, the processing of determining whether the voxel becomes a color voxel or an achromatic color voxel and causes a result of the processing to be stored in the working memory 103. Assume that the voxels are a voxel 1, a voxel 2, a voxel 3, . . . , depth data and color data are stored, for each voxel, in the working memory 103 so as to be associated with each other as follows:

voxel 1: depth data D1, color data (r1, g1, b1)

voxel 2: depth data D2, color data (r2, g2, b2)

voxel 3: depth data D3, color data (achromatic color).

The “color data (achromatic color)” of the voxel 3 indicates that the voxel 3 is an achromatic color voxel. In this example, an achromatic color is handled as one kind of color data in terms of a data format, but a parameter or a flag different from color data may be set for an achromatic color. For example, achromatic color data may be added in addition to the color data as follows:

voxel 1: depth data D1, color data (r1, g1, b1), achromatic color=0

voxel 2: depth data D2, color data (r2, g2, b2), achromatic color=0

voxel 3: depth data D3, color data (0, 0, 0), achromatic color=1.

The “achromatic color=0” indicates that a voxel is a color voxel, and the “achromatic color=1” indicates that a voxel is an achromatic color voxel.

In S303 of FIG. 6, in cases where it is determined that a voxel becomes a color voxel since the voxel satisfies a color voxel condition, color data of a closest polygon is used as it is (copied) as color data of the voxel. However, the present exemplary embodiment is not limited to this. Corrected color data of the closest polygon may be used as color data of the voxel, and the color data of the closest polygon may be corrected on the basis of depth data D. The color data of the closest polygon is corrected, for example, so that the color becomes paler as the depth data D becomes larger. By making the color paler toward an inner side of a three-dimensional object, it is possible to reproduce natural strength of color in appearance.

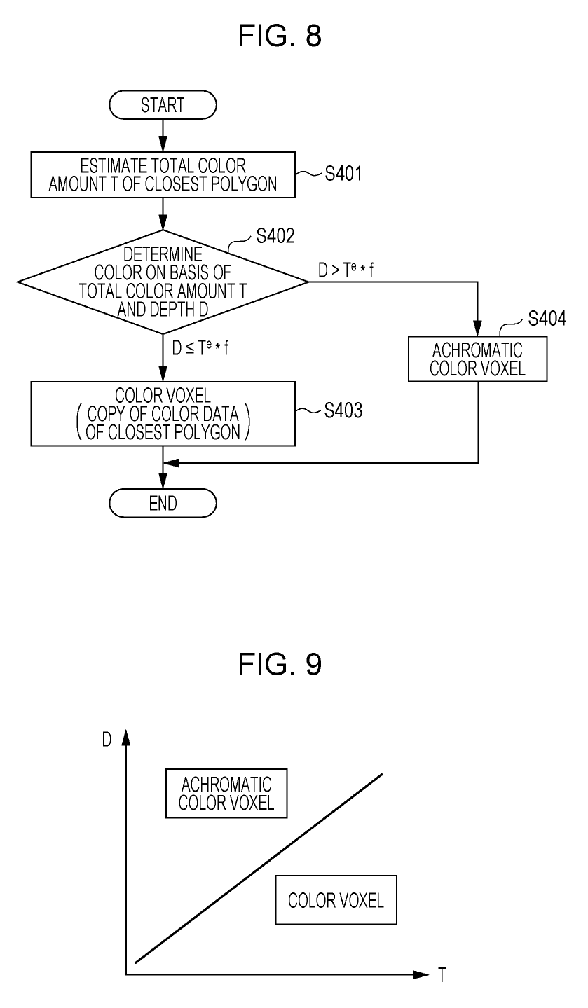

FIG. 8 is a flowchart illustrating another processing for determining color data of each voxel is performed in the CPU 101 of the data processing apparatus 10.

First, the CPU 101 determines a total color amount T of a closest polygon determined in S204 of FIG. 4 in accordance with the processing program (S401). Specifically, the CPU 101 calculates the total color amount T by performing complementary color conversion of color data (r, g, b) of the closest polygon into CMY. In the complementary color conversion, a reversal value of an input density of R is set as an input density of C, a reversal value of an input density of G is set as an input density of M, and a reversal value of an input density of B is set as an input density of Y as follows:

C(%)=100(%)−r

M(%)=100(%)−g

Y(%)=100(%)−b

The total color density T is a sum of the CMY densities and expressed as follows:

T=C(%)+M(%)+Y(%)=300(%)−(r+g+b)

Next, the CPU 101 determines color data of a voxel to be processed on the basis of the calculated total color amount T and the depth data D calculated in S204 of FIG. 4 in accordance with the processing program (S402). Specifically, the CPU 101 determines that a voxel that satisfies a preset color voxel condition expression becomes a color voxel and uses color data of the closest polygon as it is (S403). Meanwhile, the CPU 101 determines that a voxel that does not satisfy the preset color voxel condition expression becomes an achromatic color voxel (S404).

The color voxel condition expression is defined by using the depth data D and the total color amount T as follows:

D≤T^{e}*f

where e and f are coefficients and larger than 0.

The color voxel condition expression is stored in advance in the program memory 102 as part of the processing program. The above color voxel condition expression indicates that among voxels having the same depth data D, a voxel is more likely to become a color voxel as the total color amount T becomes larger and that among voxels of the same total color amount T, a voxel having smaller depth data D is more likely to become a color voxel.

FIG. 9 schematically illustrates the color voxel condition expression where e is 1 and f is 1.

It is determined that a voxel that satisfies D≤T becomes a color voxel and a voxel that satisfies D>T becomes an achromatic color voxel.

This is an example, and any combination of (e, f) can be set. In particular, the combination of (e, f) may be changed in accordance with input 3D data.

Also in the case of FIG. 8, color data of a closest polygon need not necessarily be used as it is as color data of a voxel determined as a color voxel, and instead corrected color data of the closest polygon may be used, and the color data of the closest polygon may be corrected so that the color becomes paler as the depth data D becomes larger, as in the case of FIG. 6. Specifically, color data (r2, g2, b2) of a voxel determined as a color voxel is calculated by using color data (r1, g1, b1) of a closest polygon and depth data D as follows:

r2=(100-(100−r1)*(1−D/(T^{e}*f)))

g2=(100-(100−g1)*(1−D/(T^{e}*f)))

b2=(100-(100−b1)*(1−D/(T^{e}*f)))

The expression “the color becomes paler as the depth data D becomes larger” means that the color becomes paler toward an inner side of a three-dimensional object.

As described above, in the present exemplary embodiment, color data of a voxel to be processed is determined on the basis of a distance (depth data D) from a polygon closest to the voxel and a color density (total color amount) of the closest polygon. This achieves a color strength equivalent to a single-color even in cases where a multi-color is used. Specifically, when a case where Cyan 100% is input and a case where Blue 100% is input are compared, voxels within the same depth become color voxels in these cases according to the conventional art. Meanwhile, in the present exemplary embodiment, a total color amount of Blue 100% is 200%, and voxels within a larger depth are determined as color voxels accordingly. As a result, the color of Blue 100% is stronger than the conventional one and approximates to that of Cyan 100%. In the present exemplary embodiment, there is a positive correlation between a thickness within which voxels become color voxels and a color density, and voxels within a larger thickness become color voxels as the color density becomes larger, and a stronger color is expressed accordingly.

The exemplary embodiment of the present invention has been described above, but the present invention is not limited to this and can be modified in various ways. These modifications are described below.

### Modification 1

In the exemplary embodiment, when 3D data is acquired (S101), the 3D data is converted into voxel data and it is determined whether or not a voxel becomes a color voxel (S102), and then RGB data is converted into CMYK data (S103), as illustrated in FIG. 2. Alternatively, it is also possible to employ an arrangement in which RGB data is converted into CMYK data after 3D data is acquired, and then the 3D data is converted into voxel data and it is determined whether or not a voxel becomes a color voxel. In order to determine whether or not a voxel becomes a color voxel, a total color amount of a polygon closest to the voxel to be processed is calculated. Since the total color amount is calculated after complementary conversion of RGB into CMY, the total color amount may be efficiently calculated by converting the RGB data into CMYK data beforehand.

In the exemplary embodiment, color data of 3D data supplied to the data processing apparatus 10 is RGB. However, the color data of the 3D data may be CMYK from the beginning.

### Modification 2

In the exemplary embodiment, a polygon that is located within a radius R from a voxel to be processed is searched for, and if no polygon is found, a polygon is searched for by increasing the radius R, and a distance to the polygon located within the radius R is calculated, as illustrated in FIG. 4. However, distances from a voxel to be processed to all polygons may be calculated from the beginning. However, the amount of calculation can be enormous when the distances to all polygons are calculated. Processing to be used may be changed depending on the number of polygons. For example, in cases where the total number of polygons is less than a threshold value, distances to all of the polygons may be calculated from the beginning, and in cases where the total number of polygons is equal to or larger the threshold value, the processing of the exemplary embodiment may be performed.

### Modification 3

In the exemplary embodiment, color data of a voxel to be processed is determined by using a distance (depth data D) to a closest polygon and color data (total color amount T) of the closest polygon. This can be generally expressed as follows:

color data of voxel to be processed=F(D,T)

The function F takes two values, i.e., a color voxel value and an achromatic color voxel value. A specific expression of the function F may be fixed or may be adjusted by a user of the data processing apparatus 10 and the three-dimensional object creating apparatus 12 as appropriate. The same applies to the coefficients a, b, e, and f in the exemplary embodiment, and these coefficients may be fixed or may be adjusted by a user as appropriate.

Furthermore, the above expression (color data of voxel to be processed=F (D, T)) means that color data of a voxel to be processed is determined on the basis of depth data D and a total color amount T and does not intend to exclude variables other than D and T, and the following expression using a variable X may be used:

color data of voxel to be processed=F(D,T,X)

The variable X may be, for example, a total color amount of a polygon adjacent to a closest polygon or a total color amount of a second closest polygon.

### Modification 4

In the exemplary embodiment, the data processing apparatus 10 and the three-dimensional object creating apparatus 12 are separately provided and are connected so as to be capable of exchanging data over the communication network 14. However, the data processing apparatus 10 and the three-dimensional object creating apparatus 12 may be physically united so as to constitute a three-dimensional object creating system.

Furthermore, it is also possible to employ a configuration in which the data processing apparatus 10 and a network server are connected over the communication network 14, 3D data acquired by the data processing apparatus 10 as a client is transmitted to the network server, the processes in S101 to S105 of FIG. 2 are performed in the network server, and slice data is returned to the data processing apparatus 10 that is a client or is supplied to the three-dimensional object creating apparatus 12. In this case, the network server functions as the data processing apparatus 10.

### Modification 5

In the exemplary embodiment, a voxel to be processed is classified into a color voxel or an achromatic color voxel. This is functionally equivalent to processing for extracting only color voxels. This is because voxels that are not extracted are achromatic color voxels and therefore this processing is equivalent to classifying voxels into color voxels and achromatic color voxels.

### Modification 6

In the exemplary embodiment, it is determined, for all voxels, whether or not the voxel becomes a color voxel or an achromatic color voxel by using the processing of FIG. 6 or FIG. 8. However, when a voxel is determined as an achromatic color voxel, a voxel that has larger depth data D among voxels that share a closest polygon with this achromatic color voxel is always an achromatic color voxel and therefore may be automatically determined as an achromatic color voxel. That is, when a voxel is an achromatic color voxel, voxels located deeper than this voxel are also determined as achromatic color voxels.

### Modification 7

In the exemplary embodiment, the steps S101 to S105 of FIG. 2 are executed in the data processing apparatus 10, and the step S106 is executed in the three-dimensional object creating apparatus 12. Alternatively, the steps before S103 or S104 may be executed in the data processing apparatus 10, and remaining steps may be executed in the three-dimensional object creating apparatus 12. That is, the data processing apparatus 10 may execute the process of S102 and supply voxel data (including color voxel data and achromatic color voxel data) obtained as a result of the process of S102 to the three-dimensional object creating apparatus 12. The output data of the data processing apparatus 10 may be stored once in a recording medium or the like and then supplied from the recording medium to the three-dimensional object creating apparatus 12.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A data processing apparatus comprising:
an accepting unit that accepts first data defining, for each specific surface region, a shape of a three-dimensional object and a color of a surface of the three-dimensional object; and
a generating unit that generates color voxel data from polygon data that constitute the accepted first data, the generating unit generating the color voxel data so that color information indicative of presence of a color is given to inner voxels within a larger depth from a surface voxel in a region of the first data where a density of the color of the surface is higher than in a region of the first data where the density of the color of the surface is lower.

2. The data processing apparatus according to claim 1, wherein
the generating unit generates, for all of the inner voxels that constitute voxel data, depth data indicative of a depth on a basis of a distance from the surface voxel; and
in the region where the density of the color of the surface is higher, the generating unit gives color information indicative of presence of a color to inner voxels down to an inner voxel that is given the depth data indicating a deeper position in the three-dimensional object.

3. The data processing apparatus according to claim 2, wherein
the generating unit generates, for all of the inner voxels that constitute the voxel data, the depth data on a basis of a distance between the inner voxel and a surface voxel specified as being closest to the inner voxel.

4. The data processing apparatus according to claim 3, wherein
the surface voxel that is closest to the inner voxel is specified by searching for a surface voxel within a predetermined range from a central position of the inner voxel; and
in a case where there is no surface voxel within the predetermined range, a surface voxel within the predetermined range is searched for after increasing the predetermined range.

5. The data processing apparatus according to claim 3, wherein
the distance between the inner voxel and the surface voxel specified as being closest to the inner voxel is an average of distances from a center of the inner voxel to points of a polygon.

6. The data processing apparatus according to claim 1, wherein
the generating unit determines, for each voxel to be processed, whether or not the voxel to be processed becomes a color voxel by using a distance to a polygon closest to the voxel to be processed and a color density of the polygon.

7. The data processing apparatus according to claim 1, wherein
the generating unit determines, for each voxel to be processed, whether the voxel to be processed becomes a color voxel or an achromatic color voxel by using a distance to a polygon closest to the voxel to be processed and a color density of the polygon.

8. The data processing apparatus according to claim 1, wherein
the generating unit includes a total amount calculating unit that calculates a total amount that is a sum of densities of respective color components corresponding to color signals processable in an object creating apparatus on a basis of color information of the color of the surface in the first data; and
the density of the color of the surface in the first data is determined on a basis of the total amount calculated by the total amount calculating unit.

9. The data processing apparatus according to claim 8, wherein
in a case where color components that constitute color information of the color of the surface in the first data are complementary to the color components corresponding to the color signals processable in the object creating apparatus, the generating unit converts the color information of the color of the surface in the first data into the color components corresponding to the color signals processable in the object creating apparatus by using complementary color computation and estimates the total amount that is the sum of the densities of the respective color components thus obtained.

10. The data processing apparatus according to claim 1, wherein
each of the inner voxels to which the color information indicative of presence of a color is given is given color information that is identical to color information given to a surface voxel closest to the inner voxel.

11. The data processing apparatus according to claim 1, wherein
as color data of each voxel determined as a color voxel, color data of a polygon closest to the voxel is used so that the voxel has a smaller color density in a deeper region of the three-dimensional object.

12. The data processing apparatus according to claim 1, wherein
the generating unit generates the color voxel data by giving color information indicative of presence of a color to inner voxels within a larger depth in a case where a multi-color is used than in a case where a single-color is used even though the multi-color and the single-color are same in total color amount.

13. A three-dimensional object creating system comprising:
a processing apparatus according to claim 1; and
a three-dimensional object creating apparatus that creates a three-dimensional object by using data that is output from the data processing apparatus.

14. A non-transitory computer readable medium storing a program causing a computer to execute a process for data processing, the process comprising:
accepting first data defining, for each specific surface region, a shape of a three-dimensional object and a color of a surface of the three-dimensional object; and
generating color voxel data from polygon data that constitute the accepted first data, the color voxel data being generated so that color information indicative of presence of a color is given to inner voxels within a larger depth from a surface voxel in a region of the first data where a density of the color of the surface is higher than in a region of the first data where the density of the color of the surface is lower.
